(19) United States
(12) Patent Application Publication
(10) Pub. No.: US 2026/0319506 A1
(43) Pub. Date: Oct. 15, 2026

(54) CONTROL METHOD FOR MOVABLE BODY, CONTROL DEVICE OF MOVABLE BODY, MOVABLE BODY, AND NON-TRANSITORY COMPUTER-READABLE STORAGE MEDIUM

(71) Applicant: HONDA MOTOR CO., LTD., Tokyo (JP)

(72) Inventors: Akane IMAIZUMI, Wako-shi (JP); Sango MATSUZAKI, Wako-shi (JP)

(21) Appl. No.: 19/465,430

(22) Filed: Jan. 30, 2026

(30) Foreign Application Priority Data
Mar. 26, 2025 (JP) 2025-052380

(51) Int. Cl. G05D 1/622; G05D 1/43

(52) U.S. Cl. CPC G05D 1/622; G05D 1/43

(57) ABSTRACT

A control method for a movable body, the control method comprises identifying a specific person who is a person to be identified and a position of the specific person; setting a change relationship for changing a relative relationship of the movable body with respect to the specific person; giving a notification of change information about a change to the specific person; generating a movement route for changing the relative relationship; and causing the movable body to travel along the movement route after the notification.

### CROSS-REFERENCE TO RELATED APPLICATION

This application claims priority to and the benefit of Japanese Patent Application No. 2025-052380, filed Mar. 26, 2025, the entire disclosure of which is incorporated herein by reference.

### BACKGROUND OF THE INVENTION

### Field of the Invention

The present invention relates to a control method for a movable body, a control device of a movable body, a movable body, and a storage medium.

### Description of the Related Art

A movable body such as a robot that moves together with a specific person is known. Japanese Patent Laid-Open No. 2007-229816 discloses the technique of moving a movable body away when an unspecified pedestrian other than the specific person is moving toward the movable body. Japanese Patent Laid-Open No. 2007-229816 discloses the technique of outputting sound to cause the specific person to move away when an unspecified pedestrian is moving toward the specific person.

Japanese Patent Laid-Open No. 2023-151177 discloses the technique of predicting a behavior of a user, and in a case of predicting that the user is about to enter a store, outputting information about the store.

However, in the above-described techniques, there is a problem in that when the movable body changes a relationship such as a relative position with respect to the specific person, the specific person feels uneasy.

### SUMMARY OF THE INVENTION

The present invention has been made in view of the above problem, and provides a technique capable of suppressing an uneasy feeling of a specific person, when a movable body changes a relationship such as a relative position with respect to the specific person.

According to an aspect of the present invention, there is provided a control method for a movable body, the control method comprising: identifying a specific person who is a person to be identified and a position of the specific person; setting a change relationship for changing a relative relationship of the movable body with respect to the specific person; giving a notification of change information about a change to the specific person; generating a movement route for changing the relative relationship; and causing the movable body to travel along the movement route after the notification.

According to the present invention, it becomes possible to suppress the uneasy feeling of the specific person, when the movable body changes the relationship such as the relative position with respect to the specific person.

### BRIEF DESCRIPTION OF THE DRAWINGS

FIG. 1 is a perspective view illustrating an entire configuration of a movable body according to an embodiment;

FIG. 2 is a schematic plan view illustrating a traveling unit of the movable body;

FIG. 3 is a block diagram of a control system of the movable body;

FIG. 4 is a functional block diagram illustrating functions of a control unit;

FIG. 5 is a diagram in which an image is displayed as change information on a front display unit;

FIG. 6 is a diagram for describing a case where the movable body traveling behind a user moves to a lateral side of the user;

FIG. 7 is a diagram for describing a case where the movable body traveling ahead of the user moves to a lateral side of the user;

FIG. 8 is a diagram for describing a case where the movable body traveling on a lateral side of the user moves to the front of the user;

FIG. 9 is a flowchart illustrating a processing flow of position change processing according to an embodiment;

FIG. 10 is a flowchart illustrating a processing flow of the position change processing according to a first modification;

FIG. 11 is a flowchart illustrating a processing flow of the position change processing according to a second modification; and

FIG. 12 is a flowchart illustrating a processing flow of the position change processing according to a third modification.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Embodiments

In the following embodiments, a case of using micromobility as an example of a movable body will be described as an example. Micromobility refers to, for example, a small-sized electric vehicle, which is capable of carrying baggage, and which follows or leads a user (also referred to as a specific person). However, the present embodiment may be applied to not only the micromobility capable of carrying baggage but also micromobility on which a person is able to ride. In addition, the present embodiment is not limited to an example in which the movable body is an electric vehicle, and is applicable to any movable body other than the electric vehicle. Furthermore, in the following description, a movable body including one driven wheel will be described as an example, but the driven wheel may not be necessarily included. In addition, the number of the driven wheels is not limited to one, and may be two or more.

The movable body such as the above-described micromobility is useful as long as it is possible to autonomously travel while accompanying the user. In addition, it is useful that the movable body gives a feeling of security to the user who is accompanied by the movable body.

The movable body in the present embodiment suppresses the user's uneasy feeling by giving a notification on a human machine interface (HMI) or the like, when changing a relative relationship with respect to the user such as when changing a control mode between different traveling methods, while accompanying the user.

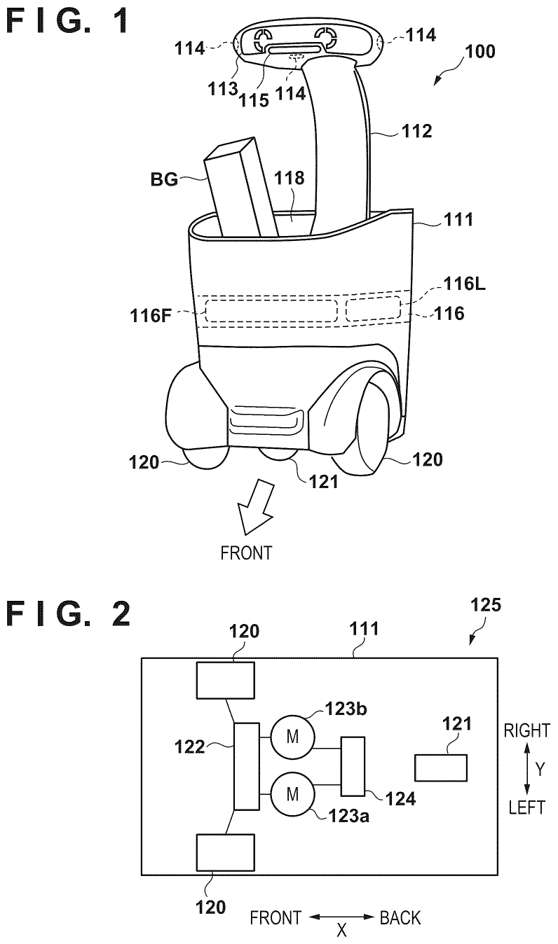

The configuration of a movable body 100 according to an embodiment will be described with reference to FIG. 1. FIG. 1 is a perspective view illustrating an entire configuration of the movable body. As illustrated in FIG. 1, the movable body 100 in an embodiment includes a lower housing 111, an upper housing 112, a front display unit 113, a plurality of detection units 114, an audio output unit 115, a light emission unit 116, two driving wheels 120, and a driven wheel 121. Note that the side on which the driving wheels 120 are provided will be referred to as the front.

The lower housing 111 rotatably holds the driving wheels 120 and the driven wheel 121, and also accommodates a traveling unit including the driving wheels 120 and the driven wheel 121. The upper portion of the lower housing 111 includes a loading space 118, into which it is possible to load the user's baggage. The lower housing 111 accommodates the light emission unit 116. The region, which accommodates the light emission unit 116, of the lower housing 111 is made of a light-transmissive material.

The upper housing 112 is configured to extend upward from a rear part of the lower housing 111. The upper housing 112 supports, at an upper end portion, the front display unit 113, the detection units 114, and the audio output unit 115.

The front display unit 113 notifies the user of information with an image. The front display unit 113 may be a display device that displays an image, such as a liquid crystal display device or an organic electro luminescence (EL) display device. The front display unit 113 is provided on the front side of an upper end of the upper housing 112. The front display unit 113 is directed forward. The front display unit 113 notifies the user of information by displaying an image imitating the face of a person, characters, and the like.

The plurality of detection units 114 detect target objects such as people and objects in the surroundings of the movable body 100. The detection unit 114 may be a digital camera including an optical system such as a lens, an image sensor, and the like. The detection unit 114 images the surroundings, and outputs image data. The detection unit 114 may include a device capable of detecting an object, such as a radar and a light detection and ranging (LiDAR), instead of or in addition to the camera. The plurality of detection units 114 are respectively provided, for example, on the front, rear, left, and right of an upper end portion of the upper housing 112. This enables the plurality of detection units 114 to image all directions (that is, around 360 degrees) of the movable body 100 and to generate images. Note that installed position and the number of the detection units 114 are not particularly limited, and may be appropriately changed.

The audio output unit 115 notifies surrounding people such as the user of information by sound. The audio output unit 115 may be a sound output device such as a speaker.

The light emission unit 116 notifies surrounding people such as the user of information by light. The light emission unit 116 includes, for example, a light emitting element such as one or a plurality of light emitting diodes (LEDs). The light emission unit 116 is provided to surround the lower housing 111. The light emission unit 116 may emit a plurality of colors. The light emission unit 116 is capable of emitting light in a different color for every region or direction. That is, for example, the light emission unit 116 emits light in a different color for each a front region 116F, a left region 116L, and a right region. In addition, the light emission unit 116 is capable of switching between turn-on and turn-off for every region. Note that with regard to the region, light emission may be controlled for a more detailed region.

The two driving wheels 120 are provided on the left and right of a front lower portion of the lower housing 111. Driving force is transmitted from the traveling unit, and then the driving wheels 120 rotate around the axle.

The driven wheel 121 is provided at a rear lower portion of the center of the lower housing 111. The driven wheel 121 is turnably held around a vertical axis extending in an up-and-down direction.

FIG. 2 is a schematic plan view illustrating a traveling unit 125 of the movable body 100. The traveling unit 125 of the movable body 100 will be described with reference to FIG. 2.

The traveling unit 125 is provided in a lower part of the lower housing 111. The traveling unit 125 includes the two driving wheels 120, the driven wheel 121, a drive mechanism 122, a motor 123a, a motor 123b, and a battery 124.

When electric power is supplied from the battery 124, the motor 123a and the motor 123b function as drive sources, and supply the driving force to the drive mechanism 122. The drive mechanism 122 transmits the driving force supplied from the motor 123a and the motor 123b to the driving wheels 120. Thus, the drive mechanism 122 rotates the driving wheels 120 to move the movable body 100 forward or backward. The drive mechanism 122 causes a rotation difference between the motor 123a and the motor 123b to set the traveling direction of the movable body 100 to either the left or the right. The drive mechanism 122 changes the magnitude of the rotation difference to achieve various turns of the movable body 100 such as pivotal turn, slow turn, and spin turn.

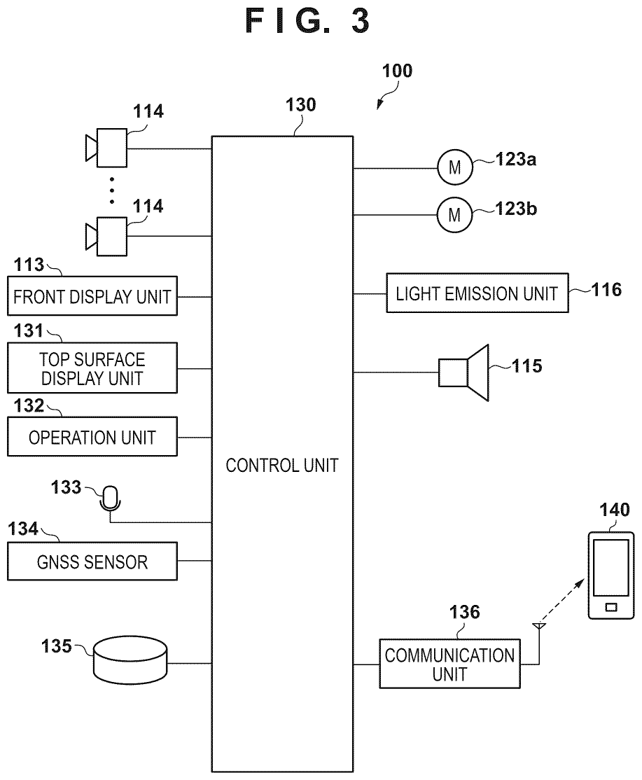

FIG. 3 is a block diagram of a control system of the movable body 100. The control system of the movable body 100 will be described with reference to FIG. 3. As illustrated in FIG. 3, the movable body 100 further includes a control unit 130, an operation unit 132, a top surface display unit 131, a voice input unit 133, a GNSS sensor 134, a storage device 135, and a communication unit 136.

The control unit 130 is an example of a control device, is also called an electronic control unit (ECU), and may be a computer. The control unit 130 conducts overall control of the movable body 100. The control unit 130 includes one or more processors represented by a central processing unit (CPU), a memory device such as a semiconductor memory, an interface with an external device, and the like.

Instead of or in addition to the CPU, the processor may be a micro processing unit (MPU), a graphics processing unit (GPU), a neural processing unit (NPU), a quantum processing unit (QPU), or the like. The processor reads and executes a computer program stored in a memory device or the like, and achieves various functions of the control unit 130.

Some or all of the respective functions of the control unit 130 may be achieved by one or a plurality of circuits such as an application specific integrated circuit (ASIC) and a programmable logic device (PLD) including a field programmable gate array (FPGA).

The memory device may be, for example, a random access memory (RAM). The memory device stores programs to be executed by the processor, data to be used for processing by the processor, and the like. A plurality of sets of processors, memory devices, and interfaces may be provided for the respective functions of the movable body 100, and each set may be configured to be communicable with each other.

The control unit 130 acquires output such as image information that has been output from the detection unit 114, user input information that has been acquired by the operation unit 132, voice information that has been output by the voice input unit 133, and the like, and performs processing in accordance with each piece of information. The control unit 130 controls the motor 123a and the motor 123b of the traveling unit 125 to conduct behavior control including traveling of the movable body 100. The control unit 130 notifies the user or a person in the surroundings of information. For example, the control unit 130 controls display of images to be displayed on the front display unit 113 and the top surface display unit 131 to notify the user of information. The control unit 130 may notify the user of information using light emission of the light emission unit 116. The control unit 130 may notify the user of the information by audio output from the audio output unit 115. The control unit 130 may perform processing using a machine learning model for image recognition (for example, a deep neural network) on image information from the detection unit 114. In addition, the control unit 130 may perform processing using the machine learning model for voice recognition (for example, the deep neural network) on voice information from the voice input unit 133.

The top surface display unit 131 may be a display device capable of displaying an image. The top surface display unit 131 is provided on an upper surface of an upper end of the upper housing 112. The top surface display unit 131 displays images, characters, and the like related to information that the user is to be notified of, based on the image information that has been acquired from the control unit 130. The top surface display unit 131 displays, for example, an operation screen for receiving an operation from the user.

The operation unit 132 may be an input device such as a touch panel or a keyboard. The operation unit 132 is provided, for example, on the display surface of the top surface display unit 131. The operation unit 132 receives an input from the user, and outputs the input to the control unit 130.

The voice input unit 133 may be a microphone or the like. The voice input unit 133 collects voice audio of the user and the surroundings of the movable body 100, and outputs the collected voice audio to the control unit 130.

The GNSS sensor 134 receives a GNSS signal from a satellite, and detects the current position of the movable body 100. Note that GNSS is an abbreviation for global navigation satellite system.

The storage device 135 includes a nonvolatile storage medium that stores various types of data. The storage device 135 may be a hard disk drive (HDD), a solid state drive (SSD), or the like. The storage device 135 may store programs to be executed by the processor, parameters necessary for executing the programs, data to be processed by the processor, and the like. The storage device 135 may store various parameters (for example, learned parameters of the deep neural network, hyperparameters, and the like) of the machine learning models for voice recognition or image recognition to be performed by the control unit 130.

The communication unit 136 communicates with an external device such as a communication terminal 140 of the user on wireless communication such as Wi-Fi or the 5th generation mobile communication system.

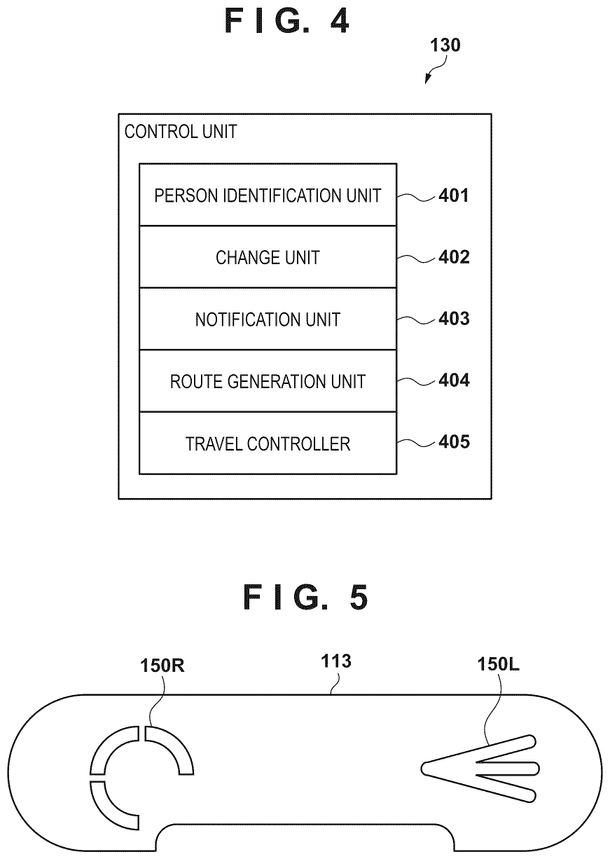

FIG. 4 is a functional block diagram illustrating functions of the control unit 130. The functions of the control unit 130 will be described with reference to FIG. 4.

The control unit 130 includes a person identification unit 401, a change unit 402, a notification unit 403, a route generation unit 404, and a travel controller 405. For example, the control unit 130 may read a program for position change processing from the storage device 135 and execute the program to implement the person identification unit 401, the change unit 402, the notification unit 403, the route generation unit 404, and the travel controller 405.

The person identification unit 401 identifies the user (also referred to as a specific person) who is a person to be identified, and also identifies the position of the user. The position of the user may be a current position or a predicted position. The position of the user may be a position with the movable body 100 as an origin. For example, the position of the user may be identified in a rotation coordinate system in which the front surface of the movable body 100 is set to 0 degrees with the movable body 100 as the origin and using the distance from the movable body 100. In addition, the position of the user may be identified on an orthogonal coordinate system with the movable body 100 as the origin. The user denotes a person who is led or followed by the movable body 100. For example, the person identification unit 401 may carry out face authentication on the image that has been acquired from the detection unit 114 to identify the user. The person identification unit 401 may identify the user using palm vein authentication, iris authentication, fingerprint authentication, or the like. The person identification unit 401 outputs an identification result to each unit.

The change unit 402 determines whether to change a relative relationship of the movable body 100 with respect to the identified user, and outputs a determination result to the notification unit 403. The relative relationship may be a relative position of the movable body 100 with respect to the user. For example, upon receipt of a gesture for instructing a change from the user, the change unit 402 may determine to change the position. The change unit 402 may perform image processing on the image that has been acquired from the detection unit 114 to determine the type of the gesture of the user. The change unit 402 may determine whether to change the position, based on a user's voice instruction that has been determined by performing voice processing on the voice audio that has been acquired from the voice input unit 133. The change unit 402 may determine whether to change the position, based on input information of the user that has been acquired from the operation unit 132. Even though there is no instruction or the like from the user, when it is determined that the user has lost their way, based on, for example, the image of the detection unit 114, the change unit 402 may determine to change the position from the rear to the front of the user.

When changing the position, the change unit 402 sets a position for changing the current relative position of the movable body 100 with respect to the user as a position after change (hereinafter, also referred to as a changed position). The changed position is an example of a change relationship. The change unit 402 may set, as the changed position, one position in a front-and-rear direction of the user to another position in the front-and-rear direction. The change unit 402 may set, as the changed position, one position in a left-and-right direction of the user to another position in the left-and-right direction. The change unit 402 may set, as the changed position, any position in the left-and-right direction of the user from any position in the front-and-rear direction. The change unit 402 may set, as the changed position, any position in the front-and-rear direction of the user from any position in the left-and-right directions. In addition, the change unit 402 may set, as the changed position, a position rotated by approximately 180 degrees from the current position of the movable body 100 with respect to the user. In other words, the change unit 402 may set, as the changed position, a position in a direction opposite to the current position of the movable body 100 with the user as the center. The change unit 402 may set, as the changed position, a position rotated by approximately 90 degrees from the current position of the movable body 100 with respect to the user.

The change unit 402 may receive a user's instruction related to a mode change. The change unit 402 may give a notification of change information in accordance with a change of the mode to change the position of the movable body 100. For example, the mode includes a following mode and a leading mode. The following mode is an example of a first control mode, and is a mode in which the movable body 100 autonomously travels behind the user while following the user. The leading mode is an example of a second control mode, and is a mode in which the movable body 100 autonomously travels ahead of the user while leading the user to guide the user. That is, the following mode and the leading mode are different from each other in the relative position of the movable body 100 with respect to the user. Therefore, when changing the mode from the leading mode to the following mode or from the following mode to the leading mode, the change unit 402 may set the changed position of the movable body 100 with respect to the user in accordance with the change.

In a case where the change unit 402 determines a change in the position, the notification unit 403 notifies the user of information about the change of the position (hereinafter, also referred to as change information). The change information may indicate changing the position. The change information may be information including a changed position.

The notification unit 403 may notify the user of the change information using the front display unit 113, the audio output unit 115, and the light emission unit 116.

For example, the notification unit 403 may display an image imitating both eyes of a human on the front display unit 113 to give the notification of the change information. FIG. 5 is a diagram in which an image is displayed as the change information on the front display unit 113. Specifically, in a case of moving from the rear to the right of the user, the notification unit 403 may display an image in which a right eye 150R is opened and a left eye 150L is closed on the front display unit 113 to give the notification of the change information including the changed position.

The notification unit 403 may output speech from the audio output unit 115 to give the notification of the change information. For example, the notification unit 403 may output speech such as “I'll change position now” or “I'll move to your right now” to give the notification of the change information.

The notification unit 403 may give the notification of the change information using a light emission state of the light emission unit 116. For example, the notification unit 403 may cause a region corresponding to the changed position in the light emission unit 116 to emit light so as to give the notification of the change information including the changed position. Specifically, in a case of moving from the rear to the left of the user, the notification unit 403 may cause a left region 116L of the light emission unit 116 to emit light and turn off the other regions so as to give the notification of the change information including the changed position.

After giving the notification of the change information, the notification unit 403 may receive a response from the user and determine whether the user has approved the position change. For example, after the notification unit 403 notifies the user of the position change, as will be described later, the notification unit 403 may determine whether the position change has been approved by a gesture, voice audio, or the like from the user. In a case where the user refuses the position change, the notification unit 403 may cancel the position change.

After giving the notification of the change information, the notification unit 403 may determine whether a preset standby period has elapsed. This suppresses the movement of the movable body 100 to the changed position immediately after the notification.

In addition, the notification unit 403 may give a notification of, as the change information, at least any of the user becoming an obstacle in changing the relative position and an instruction for avoiding the user becoming an obstacle. The user becoming the obstacle in the position change includes the user being located at the changed position, the changed position being located on the way of a predicted action of the user, the user being located on a movement route of the movable body 100, or the like. An instruction for avoiding the user becoming the obstacle includes an instruction for requesting the user to move away from the current position, an instruction for requesting the user not to move on the changed position, or the like.

After giving the notification of the change information and before the relative position is changed, the notification unit 403 may notify the user of an intention in accordance with a change in situation caused by the notification of the change information. The notification of the intention here includes after giving the notification of the change information so that the movable body 100 changes the position, notifying the user of words of gratitude when the user moves away from the current position. The fact that the user has moved away from the current position is an example of the change in the situation after the notification.

The route generation unit 404 generates a route on which the movable body 100 travels (hereinafter, also referred to as a movement route). For example, when the relative position of the movable body 100 is changed with respect to the user, the route generation unit 404 generates a movement route for changing the relative position of the movable body 100 with respect to the user. The movement route may be a route from the current position of the movable body 100 to the changed position. The route generation unit 404 may generate the movement route to the changed position so as not to include the current position or the predicted position of the user. The route generation unit 404 may generate the movement route to the changed position when the changed position is determined. Note that after the position change has been approved by voice audio, a gesture, or the like from the user, the route generation unit 404 may generate the movement route. Note that the route generation unit 404 generates the movement route to a destination position that has been set by the user. However, this is a known technique, and its description will be omitted.

The travel controller 405 controls the motors 123a and 123b to cause the movable body 100 to travel along the movement route that has been generated by the route generation unit 404. For example, after the notification of the change information is given, the travel controller 405 causes the movable body 100 to travel to the changed position along the movement route. Note that when the position change is determined, the travel controller 405 may cause the movable body 100 to travel to the changed position along the movement route.

Next, an example in which the movable body 100 changes the relative position with respect to a user SP will be described with reference to the drawings.

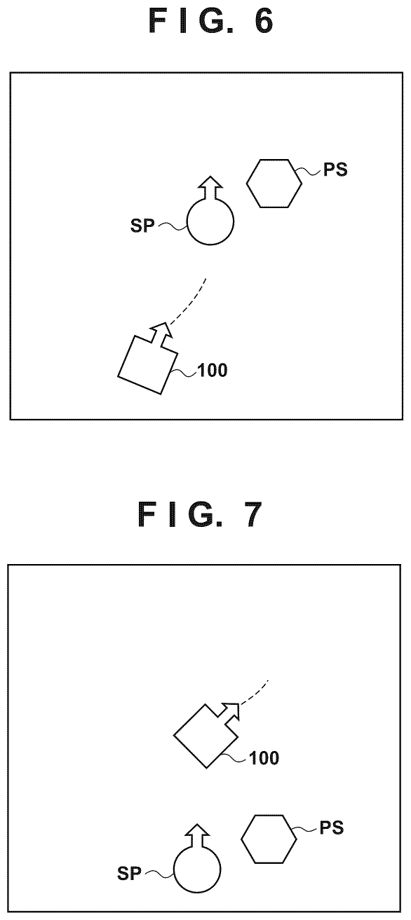

FIG. 6 is a diagram illustrating a case where the movable body 100 traveling behind the user SP moves to a lateral side of the user SP. As illustrated in FIG. 6, in the case where the movable body 100 is traveling behind the user SP, that is, in a case where the movable body 100 is following the user SP, the movable body 100 moves to a lateral side of the user SP to change the position. For example, in a case where an instruction to move to a lateral position PS is given from the user SP, the movable body 100 may change the position. The instruction may be given by voice audio, a gesture, and the like. In addition, the instruction may be an instruction to change to the leading mode instead of an instruction to move to the lateral side. The movable body 100 notifies the user of the change information, based on the instruction. For example, the movable body 100 may give a notification that the lateral position PS after change is located on the right, as the change information. In addition, in order to move to the lateral position PS, the movable body 100 may notify the user SP of a request to move leftward to make a space, as the change information. The movable body 100 may give the notification of the change information by voice audio, image, or the like.

FIG. 7 is a diagram illustrating a case where the movable body 100 traveling ahead of the user SP moves to a lateral side of the user SP. As illustrated in FIG. 7, in the case where the movable body 100 is traveling ahead of the user SP, that is, in a case where the movable body 100 is leading the user SP, the movable body 100 moves to the lateral position PS on a lateral side of the user SP to change the position. For example, in a case where an instruction to move to a lateral position PS is given from the user SP, the movable body 100 may change the position. The instruction may be given by voice audio, a gesture, or the like. In addition, the instruction may be an instruction to return to the original position instead of the instruction to move to the lateral position. The movable body 100 notifies the user of the change information, based on the instruction. For example, the movable body 100 may give a notification that the lateral position PS after change is located on the right, as the change information. In addition, in order to move to the lateral position PS, the movable body 100 may notify the user SP of a request to move in an opposite direction (here, leftward) to make a space, as the change information. The movable body 100 may give the notification of the change information by voice audio, image, or the like.

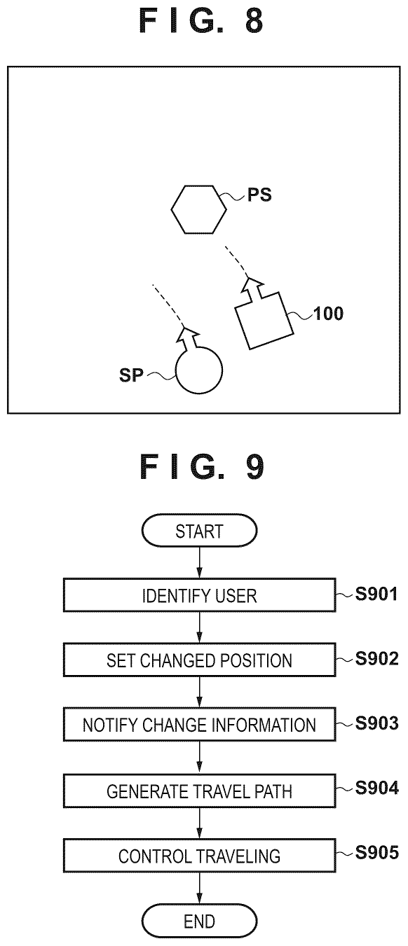

FIG. 8 is a diagram illustrating a case where the movable body 100 traveling on a lateral side of the user SP moves to the front of the user SP. As illustrated in FIG. 8, in a case where the movable body 100 is traveling on the right of the user SP, the movable body 100 moves to the front of the user SP to lead the user SP, and changes the position. In this case, for example, the movable body 100 notifies the user SP that the movable body will move in front in order to lead the user SP, as the change information. In addition, in order to smoothly move in front of the user SP, the movable body 100 may notify the user SP of a message such as “I will move in front of you, so please walk a little slowly and do not follow me” by speech or the like. Such a message is effective in a case where the user SP accelerates a certain number of times or more at the same timing as the movable body 100. After the notification, the movable body 100 may move in front of the user SP. Note that the movable body 100 may change the position to the front when the position change is approved by the user SP. Further, after moving to the front of the user SP or when an instruction to walk together is received from the user SP while moving, the movable body 100 may return to the lateral side of the user SP again to change the position. In this case, before returning to the lateral position, the movable body 100 may notify the user SP of the change information.

Position change processing in an embodiment performed by the control unit 130 will be described with reference to FIG. 9. FIG. 9 is a flowchart illustrating a processing flow of position change processing according to an embodiment.

As illustrated in FIG. 9, in the position change processing, in S901, the person identification unit 401 identifies the user, and also identifies the position of the user. The person identification unit 401 outputs information about the identified user to the change unit 402.

In S902, the change unit 402 sets the changed position for changing the relative position of the movable body 100 with respect to the user, based on the position indicated by the user information or the like. For example, in a case where the movable body 100 is located behind the user, the change unit 402 sets the front, right, or left position of the user as the changed position. Therefore, the changed position here may be a relative position with respect to the user, and may not necessarily be a position indicated on strict coordinates. The change unit 402 outputs the information about the changed position to the notification unit 403 and the route generation unit 404.

In S903, the notification unit 403 notifies the user of the change information. For example, the notification unit 403 may notify the user of changing the position and the changed position by sound or the like via the audio output unit 115. In addition, the notification unit 403 may notify the user of changing the position and the changed position by an image or the like on the front display unit 113.

In S904, the route generation unit 404 generates a movement route from the current position of the movable body 100 to the changed position. For example, the route generation unit 404 may set the position coordinates of the changed position, and generate the movement route from the current position of the movable body 100 to the position coordinates. The route generation unit 404 outputs the generated movement route to the travel controller 405.

In S905, the travel controller 405 controls the motor 123a and the motor 123b to cause the movable body 100 to travel to the changed position, based on the movement route that has been acquired. Accordingly, the control unit 130 ends the position change processing.

Hereinafter, the position change processing according to modifications will be described. Note that in the following position change processing, the same step numbers are applied to the same processing as those in the above-described embodiments, and those descriptions will be omitted or simplified. The following position change processing may be mounted on the movable body 100 together with the above-described position change processing. In this case, the movable body 100 is capable of performing several types of position change processing. The control unit 130 may select and perform one of several types of position change processing in accordance with a surrounding situation or the like. In addition, the control unit 130 may select and perform any position change processing from several types of position change processing, based on an operation instruction that has been input by the user.

### First Modification

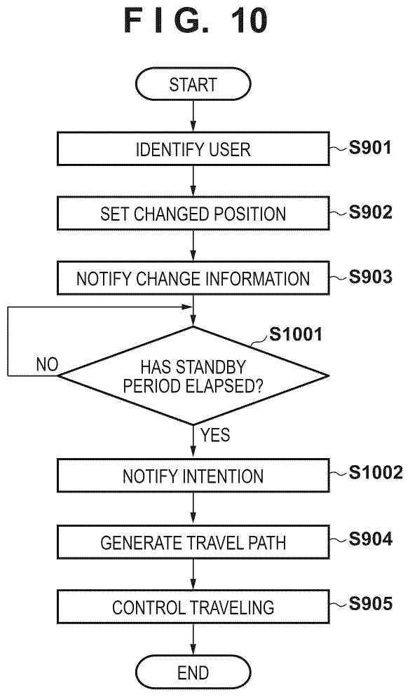

In the first modification, after the notification of the change information is given, the standby period elapses, and then the movement to the changed position starts. In the first modification, the notification of the intention may be given before the movement to the changed position starts. FIG. 10 is a flowchart illustrating a processing flow of the position change processing in the first modification. The position change processing in the first modification performed by the control unit 130 will be described with reference to FIG. 10.

As illustrated in FIG. 10, the control unit 130 performs S901 to S903.

In S1001, the notification unit 403 determines whether the standby period has elapsed since the notification of the change information was given to the user. The standby period may be a preset period of time. In addition, the control unit 130 may set or change the standby period, based on a user's input. The notification unit 403 repeats S1001 until the standby period elapses (S1001: No). On the other hand, in a case where the notification unit 403 determines that the standby period has elapsed (S1001: Yes), the processing proceeds to step S1002.

In S1002, the notification unit 403 notifies an intention. For example, the notification unit 403 may give a notification that the movement to the changed position starts now. In addition, in giving the notification of the change information, in a case where the notification unit 403 also notifies the user of a space to be made for avoiding the user together with the changed position or the like, the notification unit 403 may notify, as the intention, the user who has made the space of words of gratitude such as “Thank you for making a space” or “Thank you, I'll move in front of you”.

Then, the control unit 130 performs the processing step S904 and a subsequent step, and ends the position change processing.

### Second Modification

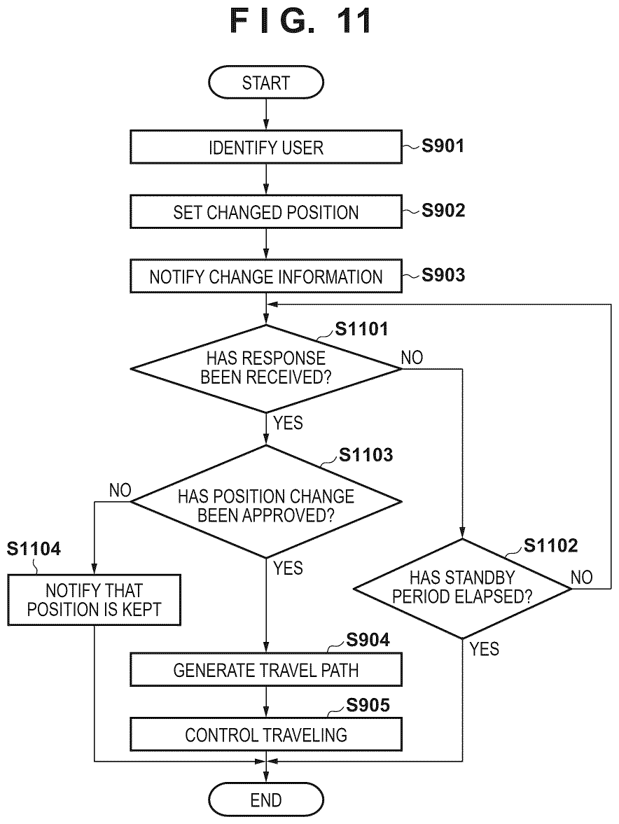

In the second modification, it is determined whether to move to the changed position, based on a response that has been received from the user. FIG. 11 is a flowchart illustrating a processing flow of the position change processing in the second modification. The position change processing in the second modification performed by the control unit 130 will be described with reference to FIG. 11.

As illustrated in FIG. 11, the control unit 130 performs S901 to S903.

In S1101, the notification unit 403 determines whether a response to the change information has been received from the user. The notification unit 403 may acquire the user's voice audio via the voice input unit 133 to determine whether the response has been received. In addition, the notification unit 403 may detect a gesture of the user, based on the image that has been acquired from the detection unit 114, to determine whether the response has been received. Further, the notification unit 403 may determine whether the response has been received, based on a reply from the user that has been acquired from the communication terminal 140.

In a case where the notification unit 403 determines that the response has been received from the user (S1101: Yes), the processing proceeds to step S1103. On the other hand, in a case where the notification unit 403 determines that no response has been received from the user (S1101: No), the processing proceeds to step S1102.

In S1102, the notification unit 403 determines whether the standby period has elapsed. In a case where the notification unit 403 determines that the standby period has not elapsed (S1102: No), the processing returns to step S1101. In other words, the notification unit 403 repeats S1101 and S1102 until a state in which no response is received from the user elapses for the standby period or more. In a case where the notification unit 403 determines that the standby period has elapsed without receiving a response (S1102: Yes), the position change processing ends.

In S1103, the notification unit 403 determines whether the received response indicates that the position change has been approved. For example, in a case where the voice audio acquired via the voice input unit 133 includes affirmative contents such as “Yes”, the notification unit 403 may determine that the change has been approved. On the other hand, in a case where the voice audio that has been acquired via the voice input unit 133 includes negative contents such as “No”, the notification unit 403 may determine that the change has been refused. In addition, in a case where the user is moving their head up and down in the image that has been acquired from the detection unit 114, the notification unit 403 may determine that the change has been approved. On the other hand, in a case where the user is moving their head side to side in the image that has been acquired from the detection unit 114, the notification unit 403 may determine that the change has been refused. Further, in a case of an affirmative reply from the user that has been acquired from the communication terminal 140, the notification unit 403 may determine that the change has been approved. On the other hand, in a case of a negative reply from the user that has been acquired from the communication terminal 140, the notification unit 403 may determine that the change has been refused. In a case where the notification unit 403 determines that the user refuses the change of the position (S1103: No), the processing proceeds to S1104. On the other hand, in a case where the notification unit 403 determines that the user approves the position change (S1103: Yes), the processing proceeds to step S904.

In S1104, the notification unit 403 gives a notification that the position is kept. For example, in a case where the movable body 100 is located ahead of the user, the notification unit 403 may give the notification that the position is kept, such as “I'm keeping this position ahead of you” or “I'm continuing to move on your right”. Then, the notification unit 403 ends the position change processing.

On the other hand, in a case where the processing proceeds to step S904, the control unit 130 performs steps S904 and S905, and ends the position change processing.

### Third Modification

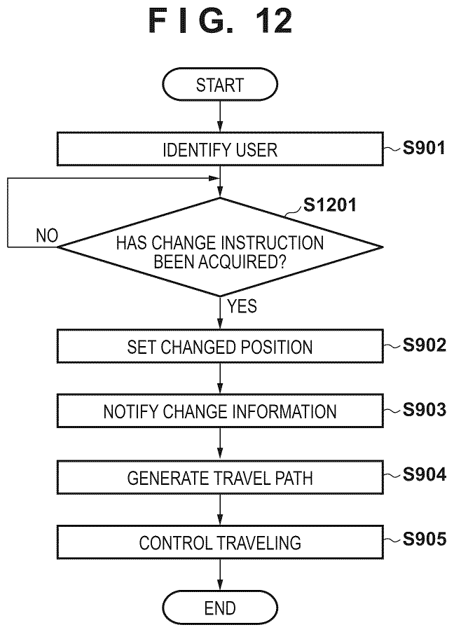

In the third modification, when a change instruction is acquired from a user, a changed position or the like is set. FIG. 12 is a flowchart illustrating a processing flow of position change processing in the third modification. The position change processing in the third modification performed by the control unit 130 will be described with reference to FIG. 12.

As illustrated in FIG. 12, the control unit 130 performs step S901.

In S1201, the change unit 402 determines whether a change instruction to change the position has been acquired from the user. The change unit 402 may directly acquire an instruction indicating the change of the position as the change instruction. For example, in a case where the movable body 100 is moving behind or ahead of the user, when acquiring an instruction by voice “Please come beside me” from the user via the voice input unit 133, the change unit 402 may determine that the change instruction to the lateral side has been acquired. In a case where the movable body 100 is moving on the lateral side of the user, when the user points their finger at the front or rear in the image that has been acquired from the detection unit 114, the change unit 402 may determine that the change instruction to the position has been acquired. In a case where the movable body 100 is moving in the front-and-rear direction or the left-and-right direction of the user, the change unit 402 may determine that the instruction to change the position is acquired, based on a transmission content by the user that has been acquired from the communication terminal 140.

Also, when acquiring an indirect instruction including the position change, the change unit 402 may determine that the change instruction has been acquired. For example, when acquiring a mode change instruction from the leading mode to the following mode or a mode change instruction from the following mode to the leading mode, the change unit 402 may determine that the change instruction to change the position has been acquired. This means that the change from the leading mode to the following mode is accompanied by the position change of the movable body 100 from the front to the rear of the user. Similarly, the change from the following mode to the leading mode is accompanied by the position change of the movable body 100 from the rear to the front of the user.

In a case of determining that the change instruction is not acquired (S1201: No), the change unit 402 repeats step S1201. Note that in a case of determining that the change instruction is not acquired (S1201: No), the change unit 402 may end the position change processing. On the other hand, in a case of determining that the change instruction is acquired (S1201: Yes), the change unit 402 performs step S902 and subsequent steps.

As described above, in the embodiments and the modifications (hereinafter, also simply referred to as “an embodiment”), when the movable body 100 changes the relative position with respect to the user, the user is notified of the change information including changing the position, the changed position, and the like. Accordingly, in an embodiment, it becomes possible to suppress the user's uneasy feeling due to the position change of the movable body 100.

In an embodiment, the words of gratitude such as “thank you” are notified as the intention in accordance with a change in the situation after the notification of the change information. Accordingly, in an embodiment, it becomes possible to communicate with the user that the change in the situation is correct.

In an embodiment, by giving a notification that the user becomes an obstacle in the position change, it becomes possible to remove the obstacle in the position change and move to the changed position with more certainty.

In an embodiment, the movement route is generated not to include the current position or the predicted position of the user, so that intersecting of the movable body 100 and the user can be suppressed.

In an embodiment, in switching between the leading mode and the following mode, the user is notified of the change information. Accordingly, in an embodiment, it becomes possible to suppress the user's uneasy feeling due to the position change in accordance with switching between modes.

In an embodiment, provision of the following mode and the leading mode enables the traveling state in accordance with the user's intention.

In an embodiment, it becomes possible to change the position of the movable body from one to another in the front-and-rear direction of the user.

In an embodiment, it becomes possible to change the position of the movable body from one to another in the left-and-right direction of the user.

In an embodiment, it becomes possible to change the position of the movable body from the front-and-rear direction to the left-and-right direction of the user or from the left-and-right direction to the front-and-rear direction.

### Other Modifications

In the above-described embodiments and modifications, an example in which the relative relationship denotes a relative position has been described. However, the relative relationship may be a relative speed of the movable body with respect to the user.

The above-described embodiments and modifications may be appropriately combined, may be configured so that the user can select combined processing or the like, or may be configured so that any combination is selectable.

Note that in the above-described embodiments, the case where the control device is the control unit 130 of the movable body 100 has been described as an example. However, the control device may be included in, for example, an information processing server present outside the movable body 100. In this case, the control device may perform a part or all of the processing performed by the above-described control unit 130 while communicating with the movable body 100. That is, the present embodiment is also applicable to a case where the movable body 100 is remotely controlled from a device separate from the movable body 100.

### Summary of Embodiments

The above embodiments disclose at least a control method for a movable body, a control device of a movable body, a movable body, and a storage medium in the following.
1. A control method for a movable body (100), the control method comprising:
identifying a specific person (SP) who is a person to be identified and a position of the specific person (SP, S901);
setting a change relationship for changing a relative relationship of the movable body (100) with respect to the specific person (SP, S902);
giving a notification of change information about a change to the specific person (SP, S903);
generating a movement route for changing the relative relationship (S904); and
causing the movable body (100) to travel along the movement route after the notification (S905).

According to this embodiment, when the movable body changes the relative relationship with respect to the specific person, the specific person is notified of the change information including changing the position, the changed position, and the like. Accordingly, in an embodiment, it becomes possible to suppress the uneasy feeling of the specific person due to the position change of the movable body.
2. In the embodiment,
after giving the notification of the change information and before changing the relative relationship, the specific person (SP) is notified of an intention in accordance with a change in a situation after the notification (S1002).

In this embodiment, in accordance with a change in the situation after the notification of the change information, words of gratitude or the like are notified as the intention. Accordingly, in this embodiment, it becomes possible to notify the specific person that the change in the situation is correct.
3. In the embodiment,
the change information includes at least one of the specific person (SP) becoming an obstacle in changing the relative relationship and an instruction to avoid the specific person (SP) becoming the obstacle.

According to this embodiment, by notifying the specific person that the specific person becomes an obstacle in the position change, it becomes possible to remove the obstacle in the position change and move to the changed position with more certainty.
4. In the embodiment,
a control mode is mounted on the movable body (100), the control mode including a first control mode, and a second control mode having a different relative relationship from the first control mode, and
upon acquisition of an instruction to change the control mode, the notification of the change information is given.

In this embodiment, when the first control mode and the second control mode are switched, the specific person is notified of the change information. Thus, in this embodiment, it becomes possible to suppress the uneasy feeling of the specific person due to the position change in accordance with the mode change.
5. In the embodiment,
the first control mode is a following mode of autonomously traveling while following the specific person (SP), and
the second control mode is a leading mode of autonomously traveling while leading the specific person (SP).

According to this embodiment, the following mode and the leading mode are provided, so that the traveling state is achieved in accordance with a specific person's desire.
6. In the embodiment,
the movement route is generated not to include the position of the specific person (SP).

According to this embodiment, the movement route is generated not to include the position of the specific person, so that intersecting of the movable body and the specific person can be suppressed.
7. In the embodiment,
the relative relationship is a position of the movable body (100) with respect to the specific person (SP), and
changing the relative relationship includes changing a position of the movable body (100) from one to another in a front-and-rear direction of the specific person (SP).

According to this embodiment, it becomes possible to change the position of the movable body from one to another in the front-and-rear direction of the specific person.
8. In the embodiment,
the relative relationship is a position of the movable body (100) with respect to the specific person (SP), and
changing the relative relationship includes changing a position of the movable body (100) from one to another in a left-and-right direction of the specific person (SP).

According to this embodiment, it becomes possible to change the position of the movable body from one to another in the left-and-right direction of the specific person.
9. In the embodiment,
the relative relationship is a position of the movable body (100) with respect to the specific person (SP), and
changing the relative relationship includes at least any of changing a position of the movable body (100) from any position in a front-and-rear direction of the specific person (SP) to any position in a left-and-right direction and changing the position of the movable body (100) from any position in the left-and-right direction of the specific person (SP) to any position in the front-and-rear direction.

According to this embodiment, it becomes possible to change the position of the movable body from the front-and-rear direction to the left-and-right direction of the specific person or from the left-and-right direction to the front-and-rear direction.

The invention is not limited to the foregoing embodiments, and various variations/changes are possible within the spirit of the invention.

What is claimed is:

1. A control method for a movable body, the control method comprising:
identifying a specific person who is a person to be identified and a position of the specific person;
setting a change relationship for changing a relative relationship of the movable body with respect to the specific person;
giving a notification of change information about a change to the specific person;
generating a movement route for changing the relative relationship; and
causing the movable body to travel along the movement route after the notification.

2. The control method for the movable body according to claim 1, wherein
after giving the notification of the change information and before changing the relative relationship, the specific person is notified of an intention in accordance with a change in a situation after the notification.

3. The control method for the movable body according to claim 1, wherein
the change information includes at least one of the specific person becoming an obstacle in changing the relative relationship and an instruction to avoid the specific person becoming the obstacle.

4. The control method for the movable body according to claim 1, wherein
a control mode is mounted on the movable body, the control mode including a first control mode, and a second control mode having a different relative relationship from the first control mode, and
upon acquisition of an instruction to change the control mode, the notification of the change information is given.

5. The control method for the movable body according to claim 4, wherein
the first control mode is a following mode of autonomously traveling while following the specific person, and
the second control mode is a leading mode of autonomously traveling while leading the specific person.

6. The control method for the movable body according to claim 1, wherein
the movement route is generated not to include the position of the specific person.

7. The control method for the movable body according to claim 1, wherein
the relative relationship is a position of the movable body with respect to the specific person, and
changing the relative relationship includes changing a position of the movable body from one to another in a front-and-rear direction of the specific person.

8. The control method for the movable body according to claim 1, wherein
the relative relationship is a position of the movable body with respect to the specific person, and
changing the relative relationship includes changing a position of the movable body from one to another in a left-and-right direction of the specific person.

9. The control method for the movable body according to claim 1, wherein
the relative relationship is a position of the movable body with respect to the specific person, and
changing the relative relationship includes at least any of changing a position of the movable body from any position in a front-and-rear direction of the specific person to any position in a left-and-right direction and changing the position of the movable body from any position in the left-and-right direction of the specific person to any position in the front-and-rear direction.

10. A control device of a movable body, the control device comprising:
an identification unit configured to identify a specific person who is a person to be identified and a position of the specific person;
a change unit configured to set a change relationship for changing a relative relationship of the movable body with respect to the specific person;
a notification unit configured to give a notification of change information about a change to the specific person;
a route generation unit configured to generate a movement route for changing the relative relationship; and
a travel controller configured to cause the movable body to travel along the movement route after the notification.

11. A movable body comprising:
the control device of the movable body of claim 10; and
an output unit configured to output the change information with at least one of an image and a sound; and
a traveling unit configured to cause the movable body to travel.

12. A non-transitory computer-readable storage medium storing a program for causing a computer to perform each step in the control method for the movable body of claim 1.
